(19) United States
(12) Patent Application Publication
(10) Pub. No.: US 2012/0217786 A1
(43) Pub. Date: Aug. 30, 2012

(54) SUPPORT DEVICE FOR VEHICLE CHILD SEAT BELT

(76) Inventor: Dai-Gil Kim, Yongin-si (KR)

(21) Appl. No.: 13/505,828

(22) PCT Filed: Nov. 4, 2010
(86) PCT No.: PCT/KR2010/007735

§ 371 Date: May 3, 2012

(30) Foreign Application Priority Data
Nov. 6, 2009 (KR) 10-2009-0106751
Jul. 26, 2010 (KR) 10-2010-0071899
Jul. 26, 2010 (KR) 20-2010-0007822

(51) Int. Cl. B60R 22/10

(52) U.S. Cl. 297/465

(57) ABSTRACT

A support device for a vehicle child seat belt tightens the shoulders and the abdominal area of a child using the existing vehicle seat belt as it is in a state where the vest type support device is easily worn on the body of the child, and which includes a cushion body for fastening the entire front face of the body of the child and an auxiliary belt for preventing the child from upwardly or downwardly escaping from the seat belt. The vehicle child seat belt support device includes: a shock-preventing cushion body formed to surround a child's body and having a seat belt receiving part formed on a front face thereof in such a fashion that the seat belt is detachably accommodated in the seat belt receiving part; and a separation-preventing auxiliary belt for supporting the back of the child so as to prevent the shock-preventing cushion body from being separated from the child's body, the separation-preventing auxiliary belt having an end joined to one side of an upper portion of the cushion body and the other end joined to one side of a lower portion of the cushion body.

### BACKGROUND OF THE INVENTION

The present invention relates to a support device for a vehicle child seat belt, which can tighten the shoulders and the abdominal area of a child using the existing vehicle seat belt as it is in a state where the vest type support device is easily worn on the body of the child, and which includes a cushion body for fastening the entire front face of the body of the child and an auxiliary belt for preventing the child from upwardly or downwardly escaping from the seat belt.

In general, a seat belt used in a vehicle is a three-point support type having support points formed at an end of an upper portion, an end of a lower portion, and the other end of the lower portion, and the positions of the support points are generally set according to the body type of regular adults.

Accordingly, in the case that a short and small person including an infant and a child seats on the right side rear seat, he or she cannot normally wear the seat belt, and hence, at the time of a car crash, there is a danger that the child gets injured because the child's face or neck is caught to the seat belt, which is inclined while going over the right shoulder, the right breast, and the left side.

FIG. 1 is a front view showing a state where a child wears a seat belt on which a vehicle seat belt support device according to a prior art.

As shown in FIG. 1, the vehicle seat belt support device 20 according to the prior art includes: a lower fastening part 23 mounted on a horizontal seat belt 11 located between a first lower support point S1 and a second lower support point S3, the lower fastening part 23 being folded and fixed upward from a lower portion in an unfolded state; and an angle controller 22 mounted on an inclined seat belt 12 located between an upper support point S2 and the second lower support point S3, the angle controller 22 being folded and fixed downward from an upper portion in an unfolded state.

However, in the case that an adult sits on the seat, on which a child sat wearing the seat belt, after the vehicle seat belt support device 20 according to the prior art is removed from the seat belt of the front seat, where the child sat, and it is decided which one of the rear seats the child will sit on, the vehicle seat belt support device 20 must be separately mounted on the seat belt of the decided seat.

Moreover, the vehicle seat belt support device 20 according to the prior art has another problem in that the child may get injured because the small child momentarily moves back and forth and is catapulted downwardly out of the horizontal seat belt 11 by the secondary collision after the rear collision of the vehicle.

Furthermore, the vehicle seat belt support device 20 according to the prior art has a further problem in that the child may get injured because the front local portions of the body of the child is strongly pressed by the horizontal seat belt 11 and the inclined seat belt 12, which are directly located on the shoulders and the abdominal area of the front side of the body of the child, at the time of a strong collision of the vehicle.

### SUMMARY OF THE INVENTION

Accordingly, the present invention has been made to solve the above-mentioned problems occurring in the prior arts, and it is an object of the present invention to provide a support device for a vehicle child seat belt, which is a vest type support device easily worn on the body of the child while fastening a seat belt of the vehicle, thereby preventing the child's body from escaping from the seat belt at the time of a car crash.

It is another object of the present invention to provide a support device for a vehicle child seat belt, which has an improved structure that maximizes safety by preventing the child from escaping upward or downward from the seat belt due to an auxiliary belt for fastening one side shoulder and the crotches of the legs as well as the other side shoulder fastened and supported by the existing vehicle seat belt and returns to its original position when the existing vehicle seat belt is released without any attaching or detaching process.

It is a further object of the present invention to provide a vest-type support device for a vehicle child seat belt, which the child can wear in safety according to the growth of the child.

It is a still further object of the present invention to provide a support device for a vehicle child seat belt, which can prevent an inclined seat belt from being separated because an inclined seat belt pocket for receiving the inclined seat belt has dual fastening means.

To accomplish the above object, according to the present invention, there is provided a support device for a vehicle child seat belt including: a shock-preventing cushion body formed to surround a child's body and having a seat belt receiving part formed on a front face thereof in such a fashion that the seat belt is detachably accommodated in the seat belt receiving part; and a separation-preventing auxiliary belt for supporting the back of the child so as to prevent the shock-preventing cushion body from being separated from the child's body, the separation-preventing auxiliary belt having an end joined to one side of an upper portion of the cushion body and the other end joined to one side of a lower portion of the cushion body.

In another aspect, the present invention provides a support device for a vehicle child seat belt including: a shock-preventing cushion body formed in a vest type to surround the front face of the body of a child, the shock-preventing cushion body having inclined seat belt pockets formed at both ends of the upper portion thereof for detachably receiving inclined seat belts therein and a horizontal seat belt pocket formed at the center of a lower portion thereof for detachably receiving a horizontal seat belt therein; and a separation-preventing auxiliary belt formed in the shape of a suspender, which is detachably joined to the shock-preventing cushion body in such a fashion that the shock-preventing cushion body surrounds and supports the front face of the body of the child without sliding down, the separation-preventing auxiliary belt having shoulder support belts, which are formed at the upper portion thereof and go over the shoulders of the child to support both shoulders of the child, and a crotch support belt, which is formed at the lower portion thereof and extends downward from the back portion of the body of the child and crosses over the crotch of the child to support the crotch between both legs of the child.

The vest-type support device for the vehicle child seat belt according to the present invention is easily worn on the body of the child without regarding to any seat of the vehicle because it is easily accommodated and fixed to the seat belt pocket of the cushion body using the existing vehicle seat belt after being worn on the body of the child and maximizes convenience and safety in use because the existing vehicle seat belt is immediately returned to its original position when the existing vehicle seat belt is released such that even adults can use it.

Moreover, the support device for the vehicle child seat belt according to the present invention can disperse shock by a momentarily local pressure of the seat belt to the whole body of the child at the time of a car crash to thereby minimize injures because the existing vehicle seat belt is regulated according to the child's body condition in such a fashion that the front whole body of the child is fastened by the vest-type cushion body. The support device for the vehicle child seat belt can prevent the child's body from escaping upward or downward from the seat belt by the benefit of the auxiliary belt for fixing the shoulder and the crotches of the legs, which are not supported by the existing vehicle seat belt, to thereby maximize safety.

Furthermore, the support device for the vehicle child seat belt according to the present invention can be folded into a small size and kept in a vehicle pocket because the cushion body is made of a flexible cushion material and the separation-preventing auxiliary belt is made of a flexible and high-tension synthetic resin material.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a front view showing a state where a child wears a seat belt to which a vehicle seat belt support device is mounted;

FIG. 2 is a perspective view of a support device for a vehicle child seat belt according to a first preferred embodiment of the present invention;

FIG. 3 is an exploded perspective view of the support device for the vehicle child seat belt according to the first preferred embodiment of the present invention;

FIG. 4 is a perspective view showing a state where of the support device for the vehicle child seat belt is worn on a child's body;

FIG. 5 is a perspective view showing a state where the child who wears the support device for the vehicle child seat belt sits on the front seat of a vehicle;

FIG. 6 is a perspective view showing a state where the child who wears the support device for the vehicle child seat belt sits on the left rear seat of the vehicle;

FIG. 7 is a perspective view of a support device for a vehicle child seat belt according to a second preferred embodiment of the present invention;

FIG. 8 is a perspective view of a crotch protection member according to the second preferred embodiment;

FIG. 9 is a perspective view showing a state where a crotch support belt of the vehicle child seat belt support device according to the second preferred embodiment is joined to a lower fastening member and the child sits on the seat of the vehicle;

FIG. 10 is a perspective view showing a state where a crotch support belt of the vehicle child seat belt support device according to the second preferred embodiment is joined to a side fastening member and the child sits on the seat of the vehicle;

FIG. 11 is a perspective view of a support device for a vehicle child seat belt according to a third preferred embodiment of the present invention; and

FIG. 12 is a view showing a state where the child wears the support device for the vehicle child seat belt according to the third preferred embodiment.

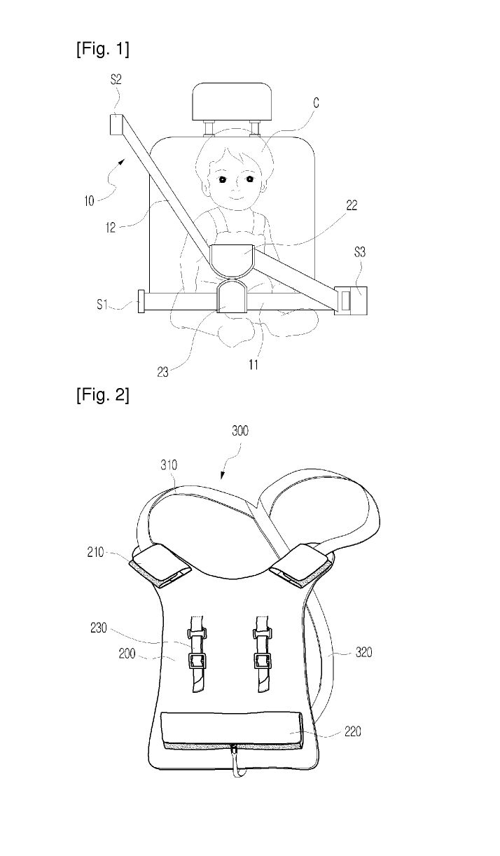

### DETAILED DESCRIPTION OF THE PREFERRED EMBODIMENT

Hereinafter, reference will be now made in detail to the preferred embodiments of the present invention with reference to the attached drawings.

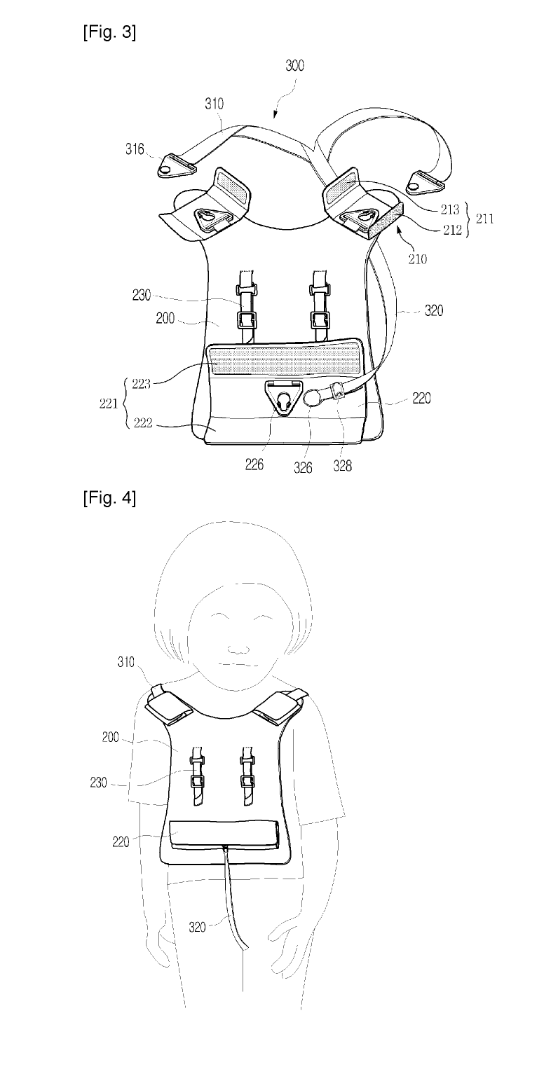

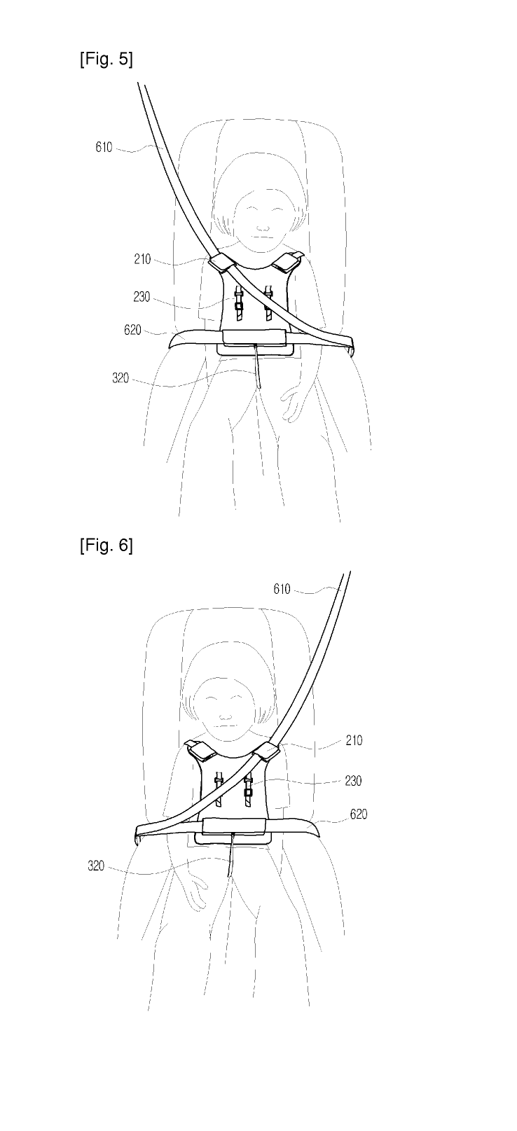

As shown in FIGS. 2 to 6, a support device for a vehicle child seat belt according to a first preferred embodiment is a vehicle child seat belt support device for regulating a vehicle seat belt in such a way as to be tightened and fit to a body type of a child, who sits on a vehicle seat, and includes: a shock-preventing cushion body 200 formed to surround the child's body and having a seat belt receiving part formed on a front face thereof in such a fashion that the seat belt is detachably accommodated in the seat belt receiving part; and a separation-preventing auxiliary belt 300 for supporting the back of the child to prevent that the shock-preventing cushion body 200 is separated from the child's body, the separation-preventing auxiliary belt 300 having an end joined to one side of an upper portion of the cushion body 200 and the other end joined to one side of a lower portion of the cushion body 200.

The shock-preventing cushion body 200 is made of a synthetic resin material or a fabric material having a cushion pad embedded therein so as to protect the child from shock transferred by a momentary pressure of the seat belt to the front face of the body of the child at the time of a car crash.

The seat belt receiving part includes: inclined seat belt pockets 210 formed at both ends of the upper portion thereof for detachably receiving inclined seat belts 610 therein; and a horizontal seat belt pocket 220 formed at the center of a lower portion for detachably receiving a horizontal seat belt 620 therein. The inclined seat belt pockets 210 and the horizontal seat belt pocket 220 can be detachably joined to the shock-preventing cushion body 200 by means of Velcro fasteners, buttons, or others. The inclined seat belt 610 and the horizontal seat belt 620 are respectively accommodated in the inclined seat belt pockets 210 and the horizontal seat belt pocket 220, and hence, it prevents the inclined seat belt 610 and the horizontal seat belt 620 from being separated due to a shock by the car crash.

The shock-preventing cushion body 200 further includes a vertical length adjusting belt 230 and a horizontal length adjusting belt 240 respectively disposed at the central portion of the front face thereof for respectively adjusting vertical and horizontal widths of the shock-preventing cushion body 200. Accordingly, when the vertical and horizontal length adjusting belts 230 and 240 are pulled or released according to size of the body of the child, the length of the shock-preventing cushion body 200 can be regulated.

The separation-preventing auxiliary belt 300 is in the form of an Y-shaped suspender, which is detachably joined to the shock-preventing cushion body 200, and includes: a shoulder support belt 310 formed at the upper portion thereof, the shoulder support belt 310 being upwardly branched from a back portion of the body of the child and going over the shoulders for supporting both shoulders of the child; and a crotch support belt 320 formed integrally with the lower portion thereof and extending downward from the back portion of the body of the child and crossing over the crotch of the child for supporting the crotch between both legs of the child. In this instance, it is preferable that the number of the crotch support belts 320 is two to balance.

Such a separation-preventing auxiliary belt 300 is an auxiliary seat belt for preventing a vertical separation by shock at the time of a car crash or collision because it supports the shoulders and the crotch of the child. In other words, the auxiliary belt 300 supports not only one side shoulder (right shoulder) supported by the inclined seat belt 610 of the vehicle seat belt but also the other side shoulder (left shoulder), so that it prevents the child from escaping left side upward from the seat belt.

The shoulder support belts 310, which are upwardly branched from the back portion of the body of the child and go over the shoulders for selectively supporting the left shoulder or the right shoulder of the child, are detachably joined to the inclined seat belt pocket 210 of the shock-preventing cushion body 200. The crotch support belt 320, which extends downward from the back portion of the body of the child and crosses over the crotch of the child for supporting the crotch between both legs of the child, is detachably joined to the horizontal seat belt pocket 220 of the shock-preventing cushion body 200.

The inclined seat belt pocket 210 and the horizontal seat belt pocket 220 respectively have first and second locking members 211 and 221. The first locking member 211 includes a first fastening portion 212 formed on one side thereof and having a female Velcro fastener and a second fastening portion 213 formed on the corresponding side of the first fastening portion 212 and having a male Velcro fastener. The second locking member 221 includes a fourth fastening portion formed on one side thereof and having a female Velcro fastener and a fifth fastening portion 223 having a male Velcro fastener. In this instance, the vehicle seat belt (including the inclined seat belt 610 and the horizontal seat belt 620) is tightly fit to the body type of the child, who sits on the vehicle seat, inside the inclined seat belt pocket 210 and the horizontal seat belt pocket 220.

Because the inclined seat belt 610 and the horizontal seat belt 620 are respectively accommodated in the inclined seat belt pocket 210 and the horizontal seat belt pocket 220 in close contact with the child's body, the seat belt pockets 210 and 220 serve to prevent the inclined seat belt 610 and the horizontal seat belt 620 from being separated by a shock due to a car crash.

Moreover, female fastening members 216 and 226, such as female buckles, are respectively attached to the inner faces of the inclined seat belt pocket 210 and the horizontal seat belt pocket 220 of the shock-preventing cushion body 200. Furthermore, male fastening members 316 and 326, such as male buckles, are respectively attached to ends of the shoulder support belts 310 and the crotch support belt 320 and are detachably coupled to the female fastening members 216 and 226. In this instance, the female fastening members 216 and 226 and the male fastening members 316 and 326 may be changed into fastening members of various coupling types, such as a clip type, a button type, a Velcro type, and others.

The support device for the vehicle child seat belt according to the first preferred embodiment of the present invention is worn on the child's body and mounted on the vehicle seat belt as described below.

First, in a state where the male fastening members 316 of the shoulder support belts 310 of the separation-preventing auxiliary belt 300 are respectively coupled to the female fastening member 216 of the inclined seat belt pocket 210 of the shock-preventing cushion body 200, an adult puts the vehicle child seat belt support device on the head of the child, who rides on the vehicle, as the child wears a vest. In this instance, the adult can regulate the length of the shock-preventing cushion body 200 by pulling or releasing the vertical and horizontal length adjusting belts 260 and 270 according to the child's body type.

After that, the male fastening member 326 (a buckle type or a hook type) of the crotch support belt 320 of the separation-preventing auxiliary belt 300 crosses over the crotch downward from the back portion of the body of the child and is fit and fastened to the female fastening member 226 of the horizontal seat belt pocket 220 of the shock-preventing cushion body 200 so as to support the crotch between the legs of the child, whereby the support device for the vehicle child seat belt can be easily and rapidly worn on the body of the child.

After that, in the case that the child sits on the right side rear seat while wearing the vehicle child seat belt support device, when the adult pulls the seat belt of the vehicle, the inclined seat belt 610 is accommodated in the inclined seat belt pocket 210 of the shock-preventing cushion body 200 and the horizontal seat belt 620 is accommodated in the horizontal seat belt pocket 220 of the shock-preventing cushion body 200. After that, when the adult covers the locking member 211 of the inclined seat belt pocket 210 and the locking member 221 of the horizontal seat belt pocket 220 (in the case that the locking members 211 and 221 are Velcro fasteners) to lock the seat belt pockets 210 and 220, the vehicle seat belt is easily and rapidly fit to the body type of the child, who sits on the vehicle seat, at the proper place.

In this instance, the female fastening member 216 and 226 and the male fastening members 316 and 326, which are made of a high-strength plastic material, are surrounded in the inclined seat belt pocket 210 and the horizontal seat belt pocket 220 not to be exposed out, and hence, the seat belt pockets provide a double buffering function together with the shock-preventing cushion body 200 so as to provide an auxiliary buffing function to prevent a momentary pressure by a car collision or crash from being transferred to the front face of the body of the child.

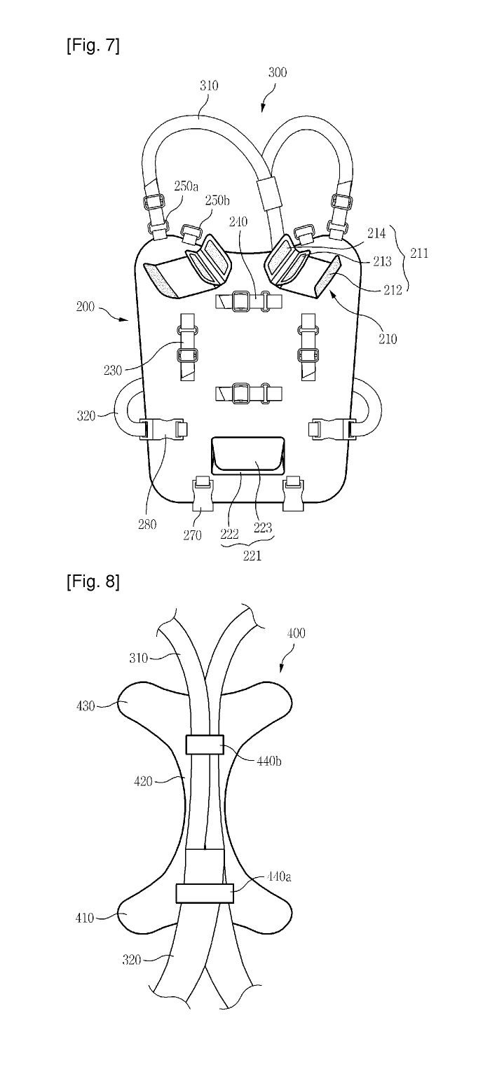

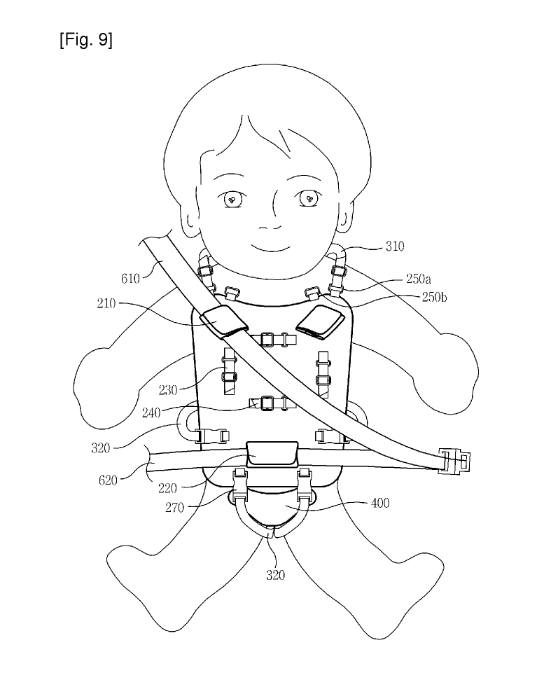

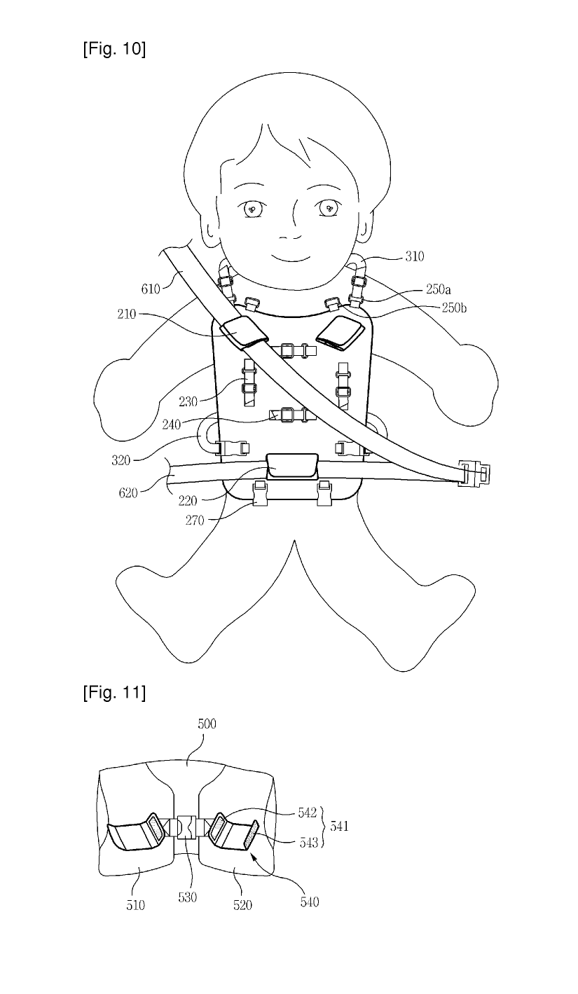

As shown in FIGS. 7 to 10, in a support device of a vehicle child seat belt according to a second preferred embodiment of the present invention, the first locking member 211 of the inclined seat belt pocket 210 includes: a first fastening portion 212 having female Velcro fasteners formed on both sides thereof; and second fastening portions 213 and 214 of two layers respectively having male Velcro fasteners formed on the corresponding faces thereof. The first locking member 211 of the inclined seat belt pocket 210 is doubly fastened in safety so as to prevent the seat belt from being separated because the female Velcro fastener of the first fastening portion 212 is doubly joined to the male Velcro fasteners of the second fastening portions 213 and 214.

Additionally, the shock-preventing cushion body 200 includes a plurality of upper fastening members 250a and 250b respectively formed at right and left sides of the top of the front face of the cushion body 200 for detachably fastening the shoulder support belts 310. In this instance, a plurality of the upper fastening members 250a and 250b can adjust fastened positions of the shoulder support belts in such a fashion that the seat belt is fit to the child's shoulders according to the child's growth.

In addition, a lower fastening member 260 for detachably fastening the crotch support belt is formed on the bottom of the front face of the shock-preventing cushion body 200. In this instance, in the case that two crotch support belts are formed, two lower fastening members 260 are respectively formed at right and left sides of the front face.

Moreover, side fastening members 280 for detachably fastening the crotch support belt 320 are formed at both sides of the front face of the shock-preventing cushion body 200. In this instance, when the crotch support belt 320 is not used due to the growth of the child, the crotch support belt is fastened to the side fastening members 280.

In the meantime, a crotch protection member 400 for protecting the crotch between the legs of the child is joined to the crotch support belt 320. The crotch protection member 400 includes: a front protector 410 extending to the front face of the child; a crotch protector 420 located between the legs of the child; and a hip protector 430 extending to the hips of the child. The front protector 410 and the hip protector 430 are wider than the crotch protector 420. Moreover, the crotch protection member 400 includes fixing rings 440a and 440b formed at the rear side thereof to prevent the crotch protection member 400 from being separated from the crotch support belt 320. In the case that the child is big, the crotch support belt 320 is joined to the side fastening member 250 of the shock-preventing cushion body 200 without passing over the crotch of the child.

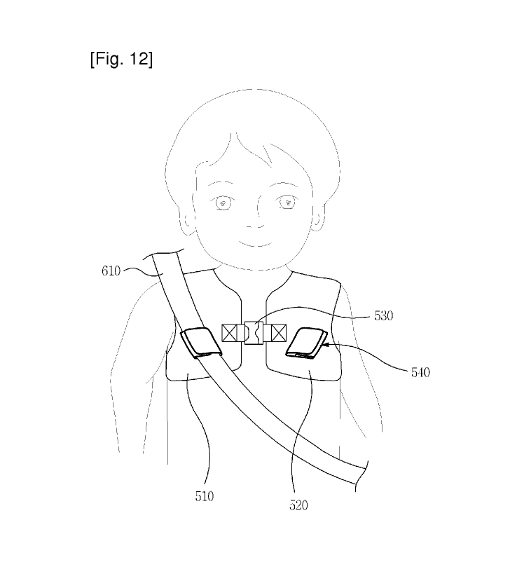

As shown in FIGS. 11 and 12, a support device for a vehicle child seat belt according to a third preferred embodiment of the present invention is a vest type support device including: a rear part 500 for supporting the back of the child; and right and left front parts 510 and 520 extending from both sides of the rear part 500 to the breast of the child, and the right and left front parts 510 and 520 respectively have fastening parts 530 for preventing the child from escaping from the seat belt in a state where the child wears the seat belt. Preferably, the fastening parts 530 are one-touch type male buckle and female buckle, but may be coupled together using buttons, slide fasteners, magic tapes, and so on.

Furthermore, inclined seat belt pockets 540 for detachably receiving the inclined seat belt 610 are respectively attached to the right and left front parts 510 and 520. The inclined seat belt pocket 540 includes a first locking member 541, which has a first fastening portion 542 having a female Velcro fastener formed on one side thereof and a second fastening portion 543 having a male Velcro fastener formed on the corresponding side. In this instance, the first locking member 541 may be fastened using buckles, buttons, slide fasteners, magic tapes, or others.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A support device for a vehicle child seat belt comprising:
a shock-preventing cushion body formed to surround a child's body and having a seat belt receiving part formed on a front face thereof in such a fashion that the seat belt is detachably accommodated in the seat belt receiving part; and
a separation-preventing auxiliary belt for supporting the back of the child so as to prevent the shock-preventing cushion body from being separated from the child's body, the separation-preventing auxiliary belt having an end joined to one side of an upper portion of the cushion body and the other end joined to one side of a lower portion of the cushion body.

2. The support device for the vehicle child seat belt according to claim 1, wherein the seat belt receiving part is an inclined seat belt pocket for receiving an inclined seat belt or a horizontal seat belt pocket for receiving a horizontal seat belt.

3. The support device for the vehicle child seat belt according to claim 1, wherein the separation-preventing auxiliary belt is detachably joined to the shock-preventing cushion body.

4. The support device for the vehicle child seat belt according to claim 1, wherein the shock-preventing cushion body comprises at least one length adjusting belt for adjusting the length of the shock-preventing cushion body.

5. The support device for the vehicle child seat belt according to claim 1, wherein the separation-preventing auxiliary belt comprises:
a shoulder support belt being upwardly branched from a back portion of the body of the child in the shape of Alphabet “Y” and going over the shoulders for supporting both shoulders of the child; and
a crotch support belt extending downward from the back portion of the body of the child and crossing over the crotch of the child for supporting the crotch between both legs of the child.

6. The support device for the vehicle child seat belt according to claim 2, wherein the inclined seat belt pocket and the horizontal seat belt pocket respectively comprise first and second locking members.

7. The support device for the vehicle child seat belt according to claim 6, wherein the first locking member comprises a first fastening portion having a female Velcro fastener formed on one side thereof and second fastening portion having a male Velcro fastener formed on the corresponding face of the first fastening portion, and the second locking member comprises a fourth fastening portion having a female Velcro fastener formed on one side thereof and a fifth fastening portion having a male Velcro fastener.

8. The support device for the vehicle child seat belt according to claim 7, wherein the first locking member comprises a first fastening portion having female Velcro fasteners formed on both sides thereof and second fastening portions of two layers respectively having male Velcro fasteners formed on the corresponding faces thereof.

9. The support device for the vehicle child seat belt according to claim 1, wherein shock-preventing cushion body further comprises: upper fastening members formed at the top of the front face thereof to detachably fasten the shoulder support belts and a lower fastening member formed at the bottom of the front face thereof to detachably fasten the crotch support belt.

10. The support device for the vehicle child seat belt according to claim 9, wherein a plurality of the fastening members are formed at right and left sides of the shock-preventing cushion body.

11. The support device for the vehicle child seat belt according to claim 1, wherein side fastening members for detachably fastening the crotch support belt to the sides of the body of the child are formed at both sides of the front face of the shock-preventing cushion body.

12. The support device for the vehicle child seat belt according to claim 1, wherein a crotch protection member for protecting the crotch between the legs of the child is joined to the crotch support belt.

13. The support device for the vehicle child seat belt according to claim 12, wherein the crotch protection member comprises: a front protector extending to the front face of the child; a crotch protector located between the legs of the child; and a hip protector extending to the hips of the child.

14. The support device for the vehicle child seat belt according to claim 1, wherein the shock-preventing cushion body further comprises a vertical length adjusting belt and a horizontal length adjusting belt respectively disposed at the central portion of the front face thereof for respectively adjusting vertical and horizontal widths of the shock-preventing cushion body.

15. A support device for a vehicle child seat belt comprising:
a shock-preventing cushion body formed in a vest type to surround the front face of the body of a child, the shock-preventing cushion body having inclined seat belt pockets formed at both ends of the upper portion thereof for detachably receiving inclined seat belts therein and a horizontal seat belt pocket formed at the center of a lower portion thereof for detachably receiving a horizontal seat belt therein; and
a separation-preventing auxiliary belt formed in the shape of a suspender, which is detachably joined to the shock-preventing cushion body in such a fashion that the shock-preventing cushion body surrounds and supports the front face of the body of the child without sliding down, the separation-preventing auxiliary belt having shoulder support belts, which are formed at the upper portion thereof and go over the shoulders of the child to support both shoulders of the child, and a crotch support belt, which is formed at the lower portion thereof and extends downward from the back portion of the body of the child and crosses over the crotch of the child to support the crotch between both legs of the child.

16. The support device for the vehicle child seat belt according to claim 15, wherein the shoulder support belts, which are formed at the upper portion thereof and go over the shoulders of the child to support both shoulders of the child, are detachably joined to the inclined seat belt pockets of the shock-preventing cushion body, and the crotch support belt, which is formed at the lower portion thereof and extends downward from the back portion of the body of the child and crosses over the crotch of the child to support the crotch between both legs of the child, is detachably joined to the horizontal seat belt pocket of the shock-preventing cushion body.

17. The support device for the vehicle child seat belt according to claim 15, wherein the inclined seat belt pockets and the horizontal seat belt pocket of the shock-preventing cushion body respectively comprise locking members.

18. The support device for the vehicle child seat belt according to claim 15, wherein female fastening members are respectively attached to the inner faces of the inclined seat belt pockets and the horizontal seat belt pocket of the shock-preventing cushion body, and male fastening members are respectively attached to ends of the shoulder support belts and the crotch support belt and are detachably coupled to the female fastening members.

19. A support device for a vehicle child seat belt comprising:
a rear part for supporting the back of the child;
right and left front parts extending from both sides of the rear part to the breast of the child;
fastening parts coupled to each other in such a fashion that the right and left front parts are connected to each other; and
inclined seat belt pockets located on the surfaces of the right and left front parts for receiving inclined seat belts therein.
